(19) United States
(12) Patent Application Publication
(10) Pub. No.: US 2024/0350358 A1
(43) Pub. Date: Oct. 24, 2024

(54) CABIN FOR WELLNESS TREATMENTS, PARTICULARLY SAUNAS, STEAM BATHS AND THE LIKE

(71) Applicant: STARPOOL S.R.L., Ziano di Fiemme (TN) (IT)

(72) Inventor: Riccardo TURRI, Ziano di Fiemme (TN) (IT)

(21) Appl. No.: 18/693,350

(22) PCT Filed: Sep. 20, 2022
(86) PCT No.: PCT/IB2022/058865

§ 371 Date: Mar. 19, 2024

(30) Foreign Application Priority Data
Sep. 21, 2021 (IT) 102021000024176

(51) Int. Cl. A61H 33/06

(52) U.S. Cl. CPC A61H 33/067; A61H 33/065; A61H 2033/061; A61H 2033/068; A61H 2201/0207; A61H 2201/0228; A61H 2201/50

(57) ABSTRACT

The cabin (1) for wellness treatments, particularly saunas, steam baths and the like comprises: a containment structure (2) comprising a plurality of walls (3) coupled to each other and defining at least one treatment space (4) adapted to accommodate at least one user, the plurality of walls (3) comprising at least one access wall (3a) for the access to the treatment space (4), at least one back wall (3b) opposite the access wall (3a), and at least one pair of side walls (3c, 3d) opposite each other and located between the access wall (3a) and the back wall (3b); and at least 2 one air conditioning system (6) of the treatment space (4) comprising at least heating means (7) and at least one electronic management and control unit (U) of the heating means (7): in which the air conditioning system (6) is associated with the back wall (3b), each of the side walls (3c, 3d) being devoid of the heating means (7) and of the electronic management and control unit (U).

### TECHNICAL FIELD

The present invention relates to a cabin for wellness treatments, particularly saunas, steam baths and the like.

### BACKGROUND ART

As is well known, cabins for wellness treatments are usually provided with a containment structure that defines within it a treatment area adapted to accommodate one or more users and within which predefined environmental conditions, such as a hot dry area in the case of saunas and a hot humid area in the case of steam baths, are generated, such as to bring well-being to the user. For this purpose, the cabins are usually provided with a special air conditioning system capable of generating heat which, depending on the type of treatment carried out, is either dry or wet.

For example, in the case of steam baths, the air conditioning system is adapted to generate humid heat, that is, to inject steam into the treatment area. Alternatively, in the case of saunas, the air conditioning system is adapted to generate dry heat.

The air conditioning system is usually provided with heating means to generate either dry or wet heat and with an electronic management and control unit to manage and control the heating means which is operatively connected to the latter by means of appropriate wiring harnesses.

Generally, the containment structure involves a plurality of side walls, usually four, among which are identified at least one access wall provided with one door for the entry into the compartment, a back wall opposite the access wall, and a pair of side walls opposite each other and positioned between the back wall and the access wall.

In known cabins, the back wall and the pair of side walls are so-called technical walls, that is, walls with which the various components of the air conditioning system are associated.

Specifically, each technical wall has a supporting framework with which are associated a layer of insulating material, arranged on the outside of the cabin, and a finishing panel, arranged on the inside of the cabin. The insulation layer is machined so as to create an inter-space within which part of the air conditioning system elements, such as e.g. a heating element, piping, etc., are placed. Next, the inter-space is sealed, e.g. by grouting. Finally, the technical walls are covered by applying the finishing panel, which can be made from different materials depending on the user's needs, such as e.g. glass, marble or similar materials.

Such well-known cabins, however, do have several problems related, in particular, to the high production lead times and the lack of flexibility and possibility of customizing the cabin even while the work is in progress. In fact, once the walls are completed, any changes requested by the customer, such as a change of material in the finishing panel, are difficult to implement and require extremely long timelines.

In addition, the production timing of the cabin is affected by the sealing process of the inter-space, which requires high drying times.

Adding to these drawbacks is the fact that the electronic management and control unit of the air conditioning system is usually housed in an externally sliding trolley arranged adjacent to one of the technical walls to connect it to the heating means, e.g. through holes or openings made in the wall.

However, this solution involves problems related to the fact that the sliding trolley is extremely bulky and usually occupies an external space that remains effectively unusable by the user.

### DESCRIPTION OF THE INVENTION

The main aim of the present invention is to devise a cabin for wellness treatments, particularly saunas, steam baths and the like that allows drastically reducing the production time compared to known cabins.

One object of the present invention is to devise a cabin for wellness treatments, particularly saunas, steam baths and the like that allows a high degree of customization and flexibility, allowing the customer to make changes even while the work is in progress.

Another object of the present invention is to devise a cabin for wellness treatments, particularly saunas, steam baths and the like that allows for simplified production and assembly of the treatment area walls.

A further object of the present invention is to devise a cabin for wellness treatments, particularly saunas, steam baths and the like that will allow decreasing the installation time of the cabin.

Still one object of the present invention is to devise a cabin for wellness treatments, particularly saunas, steam baths and the like that allows the aforementioned drawbacks of the prior art to be overcome within the framework of a simple, rational, easy and effective to use as well as affordable solution. The aforementioned objects are achieved by this cabin for wellness treatments, particularly saunas, steam baths and the like, having the characteristics of claim 1.

### BRIEF DESCRIPTION OF THE DRAWINGS

Other characteristics and advantages of the present invention will become more apparent from the description of a preferred, but not exclusive, embodiment of a cabin for wellness treatments, particularly saunas, steam baths and the like, illustrated by way of an indicative, yet non-limiting example in the attached tables of drawings in which:

FIG. 1 is a perspective view of the wellness treatment cabin in accordance with the present invention,

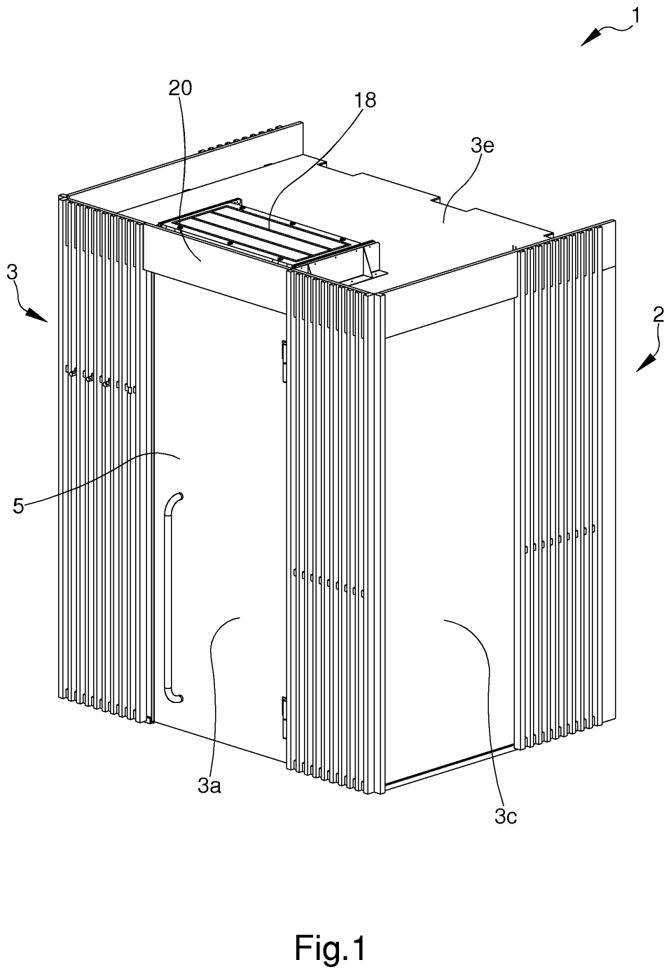

FIG. 2 is a perspective view of a sauna-type cabin in which the access wall has been removed for better clarity,

FIG. 3 is a perspective view of a steam bath-type cabin in which the access wall has been removed for better clarity,

FIG. 4 is a sectional view of the cabin in FIG. 3,

FIGS. 5 and 6 are detailed views of the joining means,

FIG. 7 is a detailed view of the profiled element of the joining means.

### EMBODIMENTS OF THE INVENTION

With particular reference to these figures, reference numeral 1 globally indicates a cabin for wellness treatments, particularly saunas, steam baths and the like.

In particular, it is specified that within the scope of this disclosure the expression “cabins for wellness treatment” refers to rooms adapted to accommodate one or more users and within which predefined and controlled thermo-hygrometric conditions are generated, such as, e.g., a hot dry area in the case of saunas and a hot humid area in the case of steam baths, and such as to bring well-being to the user.

Appropriately, the cabin 1 comprises at least one containment structure 2 provided with a plurality of walls 3 coupled to each other and defining at least one treatment space 4 adapted to accommodate at least one user.

Specifically, the plurality of walls 3 comprises at least one access wall 3a for the access to the treatment space 4, at least one back wall 3b opposite the access wall 3a, and at least one pair of side walls 3c, 3d opposite each other and located between the access wall 3a and the back wall 3b. Preferably, the access wall 3a comprises a door 5 for the user entry into the treatment space 4.

Additionally, the containment structure 2 comprises at least one upper closing wall 3e and, preferably, a lower wall 3f.

It cannot be ruled out from the scope of this disclosure that the lower wall 3f may coincide with the lower wall of the room where the cabin 1 is placed. As a whole, the containment structure 2 has a substantially box shape having a rectangular or square plan in which the walls 3 are arranged adjacent and transverse to each other two by two. It cannot however be ruled out that the containment structure 2 may have different conformations.

Conveniently, the cabin 1 is provided with at least one air conditioning system 6 of the treatment space 4.

The air conditioning system 6 is configured to control and modify the climatic conditions within the treatment space 4 in order to achieve a room that has certain comfort conditions depending on the type of cabin 1.

For example, the air conditioning system 6 can be configured, in the case of a sauna, to have a hot dry area or, in the case of a steam bath, a hot humid area.

Specifically, the air conditioning system 6 comprises at least heating means 7 and at least one electronic management and control unit U of the heating means 7.

As described in detail later in this disclosure, the heating means 7 comprise at least one heat generating unit 8.

Specifically, in the event of the cabin 1 being a steam bath, the heating means 7 comprise at least one heat generating unit 8 and one steam production and dispensing unit 9.

Advantageously, the air conditioning system 6 is associated with the back wall 3b, each of the side walls 3c, 3d being devoid of the heating means 7 and of the electronic management and control unit U.

In actual facts, the back wall 3b is the only technical wall, while the other walls 3a, 3c, 3d are infill walls.

Since infill walls are easier and quicker to make than technical walls, this expedient makes it possible to significantly reduce the construction time of the cabin 1. In addition, the infill walls can be made with greater freedom of choice in materials and are also easily modified, even during construction.

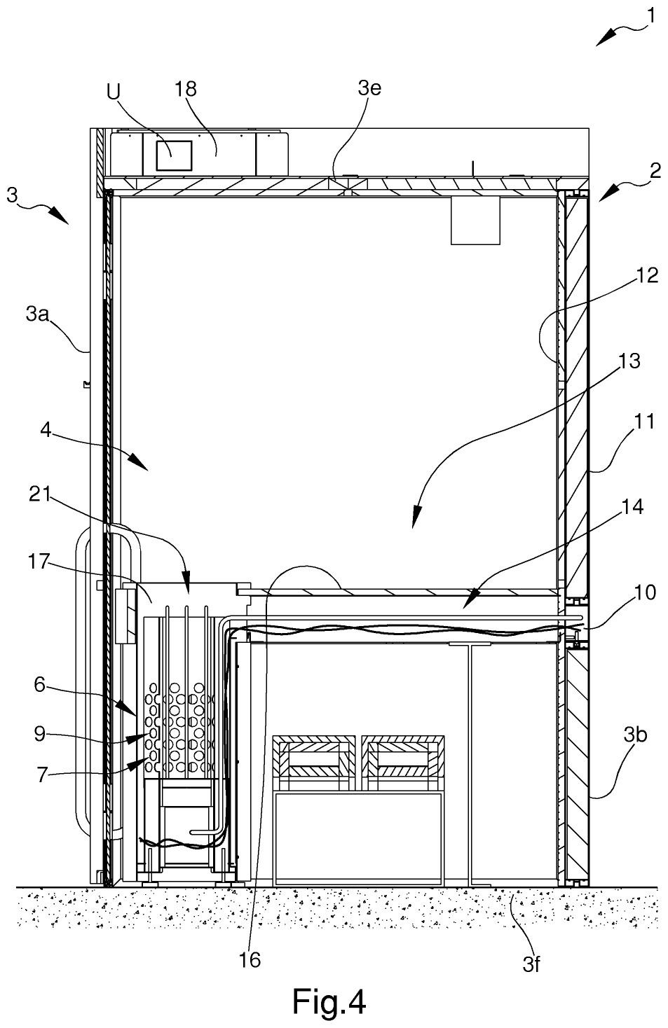

As can be observed from FIG. 4, the back wall 3b comprises at least one housing seat 10 adapted to house at least part of the air conditioning system 6. Preferably, in accordance with a preferred embodiment of the cabin 1 depicted in the figures, the heating means 7 are uniquely and directly associated with the back wall 3b.

This means that the heating means 7 are housed at least partly within the housing seat 10. It cannot however be ruled out from the scope of this disclosure that the electronic management and control unit U is also housed within the housing seat 10.

Preferably, the housing seat 10 is of the type of an inter-space made inside the back wall 3b.

In detail, the back wall 3b comprises at least one outer face 11 and one inner face 12 facing the outside and the inside of the treatment space 4, respectively. The outer face 11 and the inner face 12 are spaced apart from each other by an inter-space defining the housing seat 10.

In other words, the housing seat 10 is positioned between the two faces 11, 12.

Preferably, the housing seat 10 is arranged transversely to the back wall 3b and, preferably, substantially horizontally.

However, the housing seat 10 can be arranged in different manners and have different sizes depending on the type and characteristics of the air conditioning system 6.

For example, in the event of the air conditioning system 6 involving the use of a heating layer, the housing seat 10 may be obtained along substantially the entire back wall 3b.

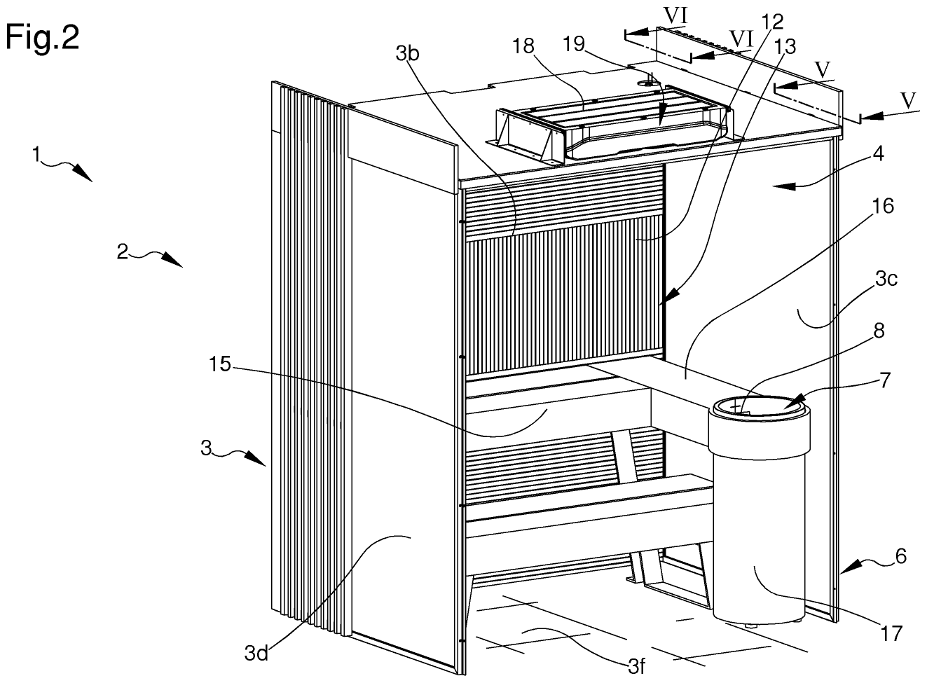

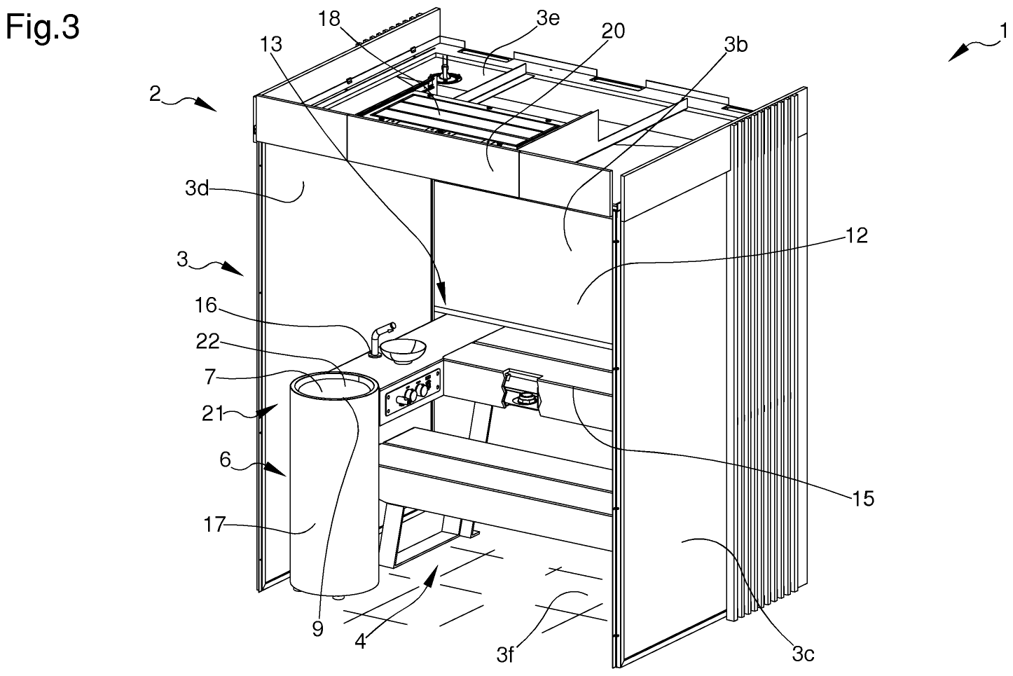

As can be observed from FIGS. 2 and 3, the treatment space 4 comprises at least one shelf element 13 associated with the back wall 3b. The shelf element 13 has at least one cavity 14 in communication with the housing seat 10 and adapted to house at least part of the heating means 7 and/or of the electronic management and control unit U.

The shelf element 13 allows the elements of the air conditioning system 6 to be carried from the back wall 3b to the inside of the treatment space 4, keeping them substantially associated with only the back wall 3b.

For example, one or more components of the heating means 7 can be associated with the shelf element 13, and the respective electronic connections with the electronic management and control unit U can be carried through the back wall 3b and the cavity 14 of the shelf element 13.

In this case, the shelf element 13 protrudes cantilevered from the back wall 3b and extends transversely from the latter.

Conveniently, the shelf element 13 is used as a furniture component of the treatment space 4.

In particular, the shelf element 13 is configured to serve as the user's support, e.g., it can be used as a seat.

In this regard, the shelf element 13 comprises a supporting portion 15 of the user. Preferably, the supporting portion 15 is arranged at a height from the lower wall 3f comprised between 85 cm and 105 cm, preferably 92 cm.

Alternatively, the shelf element 13 is configured to allow the support of the heating means 7 or, alternatively, other components such as e.g. tapware.

As can be observed from FIG. 3, preferably, the shelf element 13 comprises one or more portions 15, 16 that extend inside the treatment space 4 from the back wall 3b. The portions 15, 16 have respective cavities 14 communicating with each other.

In a preferred embodiment, the shelf element 13 has a substantially L-shaped conformation wherein a connecting portion 16 and a supporting portion 15 arranged transversely to each other are identified. The connecting portion 16 extends longitudinally transverse to the back wall 3b, while the supporting portion 15 extends longitudinally parallel to the back wall 3b.

It cannot however be ruled out that the shelf element 13 may have different conformations wherein there are different portions or that the supporting portions 15 and the connecting portions 16 coincide with each other. As anticipated above, the supporting portion 15 is used to make a seat for the user.

Instead, the connecting portion 16 is adapted to connect the back wall 3b to the heating means 7 so that they can be arranged inside the treatment space 4. In addition, the shelf element 13 can serve as a support for accessory and/or furniture elements, such as e.g. one or more audio speaker elements mounted below the supporting portion 15, as shown in FIG. 3.

In detail, the air conditioning system 6 comprises at least one containment element 17 of at least part of the heating means 7.

The connecting portion 16 of the shelf element 13 is positioned between the containment element 17 and the back wall 3b to allow the connection between the electronic management and control unit U to at least part of the heating means 7.

Preferably, the containment element 17 has a substantially cylindrical shape. Even more preferably, the containment element 17 extends lengthwise along a substantially vertical direction.

Conveniently, the cabin 1 comprises supporting means for supporting at least one user's cover sheet. Specifically, the supporting means allow the cover sheet to be supported during the user's wellness treatment.

For this purpose, the supporting means comprise at least one flexible element associated with the back wall 3b and around which the cover sheet can be at least partly wound. The flexible element is arranged superiorly to a user's supporting surface. Preferably, the flexible element is arranged above the supporting portion 15 of the shelf element 13.

As anticipated above, the containment structure 2 comprises an upper closing wall 3e.

Conveniently, the upper closing wall 3e comprises at least one housing compartment 18 adapted to house the electronic management and control unit U. This expedient further reduces the space occupied by the cabin 1 within the room in which it is installed.

Preferably, the housing compartment 18 is arranged outside the treatment space 4.

The possibility cannot however be ruled out that the housing compartment 18 be arranged inside the treatment space 4.

Conveniently, the housing compartment 18 comprises an inlet port 19 and at least one leaf 20 associated with the inlet port 19. The leaf 20 is movable between an opening position, wherein it is moved away from the inlet port 19 to allow access from the outside to the housing compartment 18 and to the electronic management and control unit U, and a closure position wherein it is arranged to cover the inlet port 19 to prevent access from the outside to the housing compartment 18 and to the electronic management and control unit U. Conveniently, the air conditioning system 6 comprises one or more wiring harnesses connecting the management and control unit U to the heating means 7. The wiring harnesses are at least partly associated with the back wall 3b. Specifically, the wiring harnesses are arranged inside the back wall 3b and extend along the latter between the housing seat 10 and the upper closing wall 3e.

Appropriately, the back wall 3b comprises one or more sheaths cut out inside the latter and within which the wiring harnesses are at least partly arranged.

Preferably, the wiring harnesses are of the quick-connect type with the couplings to connect at least the electronic management and control unit U and/or the heating means 7.

As anticipated above, the cabin 1 can be, e.g., a sauna or a steam bath.

In the embodiment shown in FIG. 2, the cabin 1 is of the type of a sauna in which the air conditioning system 6 is configured to generate dry-type heat. Preferably, the heating means 7 comprise a heat generating unit of the type of an electric heater housed in the containment element 17.

It cannot however be ruled out that the heat generating unit may be of a different type, such as e.g. a layer of heating wall positioned between the outer layer and the inner layer.

In the embodiment shown in FIG. 3, on the other hand, the cabin 1 is of the type of a steam bath wherein the heating means 7 comprise at least one steam production and dispensing unit 9.

Preferably, the steam production and dispensing unit 9 is housed at least partly in the containment element 17.

In the present case, the steam production and dispensing unit 9 comprises a steam generating means 21 housed in the containment element 17, and a steam diffusing means 22 associated with the containment element 17 and arranged at an upper portion of the latter.

Preferably, the steam production and dispensing unit 9 comprises one or more solenoid valves housed in the containment element 17 to adjust the outflow of the steam.

In addition, the air conditioning system 6 comprises steam interception and regulation means associated with at least one of either the back wall 3b or the shelf element 13. Preferably, the steam interception and regulation means are of the type of a tap. In particular, the steam interception and regulation means comprise one or more tap elements adapted to intercept and regulate the influx of steam and/or of a liquid.

Preferably, the steam interception and regulation means are associated with the shelf element 13.

Appropriately, the cabin 1 comprises joining means 23 associated with the sides of at least one pair of adjacent walls 3 in such a way that they can be associated with each other.

Specifically, by “adjacent walls” is meant a pair of walls out of the plurality of walls 3 that are joined together, or alternatively, a pair of portions of the same wall 3.

Preferably, the joining means 23 are associated with the sides of each wall 3 in such a way that they can be associated with each other.

Specifically, the joining means 23 are positioned between a pair of walls 3 adjacent to each other or, in some versions, between two portions of the same wall 3, to make an airtight connection. In this way, the walls 3 can be joined together without the need for subsequent work adapted to achieve a seal. Such joining means 23 are mainly used for the cabins 1 of the type of steam baths in order to prevent unwanted steam from escaping from the joining points of the walls.

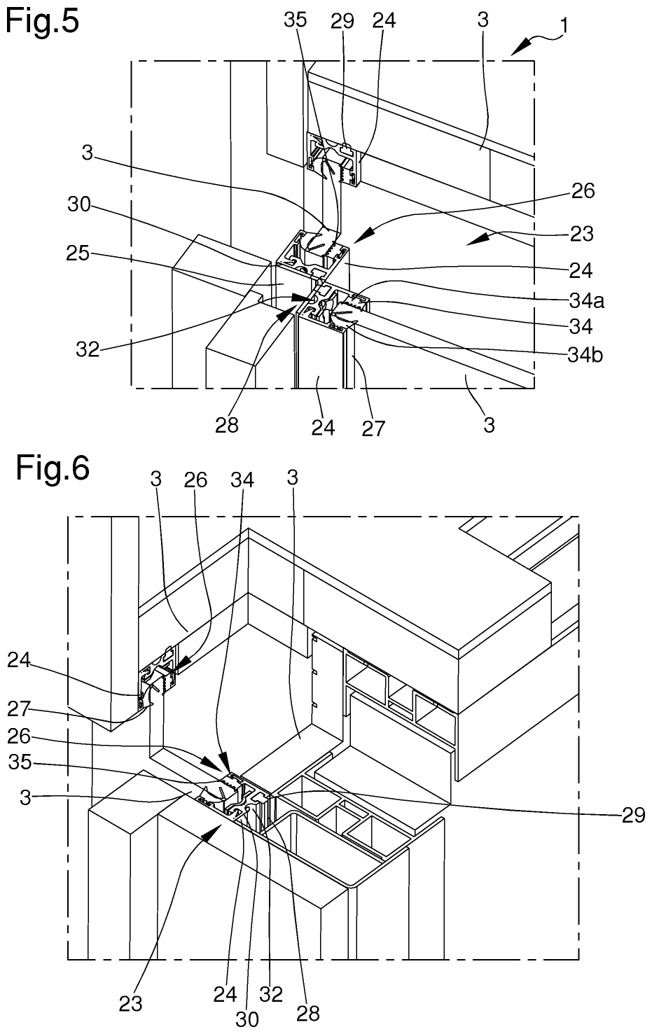

As can be observed from FIGS. 5, 6 and 7, the joining means 23 comprise at least one profiled element 24 extending along one longitudinal direction and intended to fit between the sides of at least two of the walls 3.

In detail, the profiled element 24 is placed between the pair of walls 3 to make an airtight connection.

Preferably, the profiled element 24 is associated with one wall 3 of the pair of adjacent walls and connects by stopping to the other wall 3 of the pair of adjacent walls. Even more preferably, the profiled element 24 connects by stopping to a corner element 25 positioned between the pair of adjacent walls. The profiled element 24 extends substantially along the entire length of the sides of the wall 3 with which it is associated.

Appropriately, each wall 3 of the pair of adjacent walls is associated with a respective profiled element 24, the latter being intended to connect by stopping where the other wall 3 of the pair of adjacent walls is located.

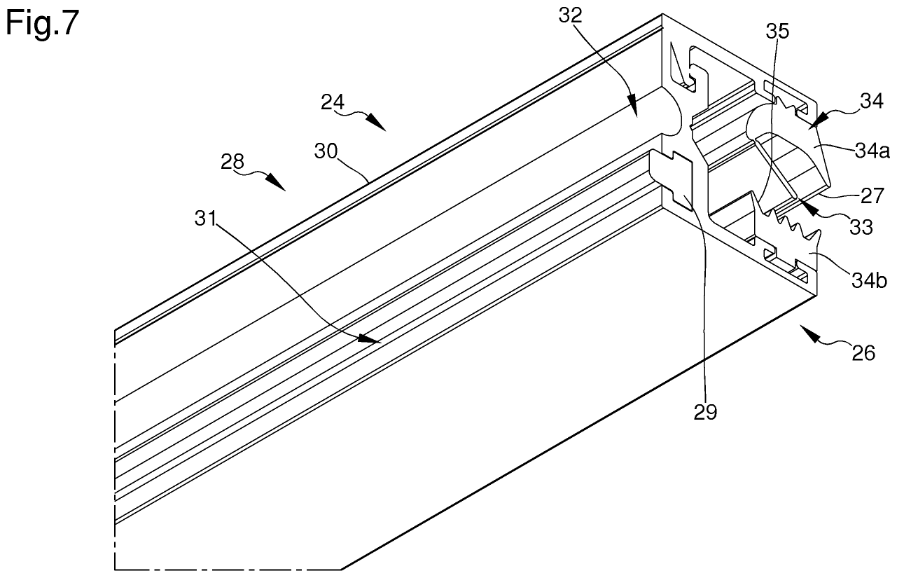

As can be observed from FIG. 7, the profiled element 24 comprises at least one main portion 26 extending along a longitudinal direction and defining a supporting surface 27 for the side of one of the walls 3. In addition, the profiled element 24 comprises at least one retaining portion 28 opposite the main portion 26 extending parallel to the longitudinal direction.

Specifically, the main portion 26 is intended to be associated with one of the walls 3 of the pair of adjacent walls, while the retaining portion 28 is intended to be connected to the other of the walls 3 of the pair of adjacent walls.

In detail, the main portion 26 of the profiled element 24 is mounted onto one of the walls 3. Then, when the pair of adjacent walls 3 are joined together, the retaining portion 28 of the profiled element is connected to the other wall, or to the corner element.

As can be observed from FIG. 6, the profiled element 24 has, in cross section, a substantially rectangular or square profile in which at least four sides are identified. Preferably, the main portion 26 and the retaining portion 28 are formed at two opposite sides to each other.

Conveniently, the profiled element 24 comprises at least a first seal element 29 associated with the retaining portion 28. The seal element 29 is adapted to adhere by stopping to the other wall of the pair of adjacent walls, making an airtight connection. For this purpose, the seal element 29 is made at least partly of an insulating material. In detail, the seal element 29 is made at least partly of silicone.

Since the profiled element 24 is directly mounted on one of the two adjacent walls, joining the latter does not require any additional sealing operations, resulting in faster installation of the cabin 1.

Appropriately, the retaining portion 28 comprises at least one contact surface 30, in use, intended to abut against the side of one of the walls 3. The seal element 29 is associated with the contact surface 30 in order to abut against the other wall 3, in order to be compressed and achieve an airtight seal. The contact surface 30 extends substantially along the longitudinal direction of the profiled element.

Conveniently, the seal element 29 has a conformation complementary to the contact surface 30 so that, in use, it abuts against the side of one of the walls 3 and seals the treatment space 4 in an airtight manner.

In the present case, as can be observed from FIG. 7, the retaining portion 28 has a first groove 31 cut from the contact surface 30. The seal element 29 is arranged at least partly in the groove 31. For this purpose, the seal element 29 has at least one main body substantially complementary to the groove 31 and intended to fill the latter. In addition, conveniently, the seal element 29 has at least one auxiliary body protruding from the groove 31 whereby, when the contact surface 30 abuts against the other wall, such portion of the seal element 29 is compressed thus making an airtight seal.

Appropriately, the seal element 29 completely fills the groove 31.

Preferably, the groove 31 extends along the longitudinal direction. Also preferably, the groove 31 has, in cross section, a substantially “C”-shaped profile in which a compartment and an access to the compartment are identified. Conveniently, the access has a smaller width than the compartment.

As can be observed from FIG. 7, the retaining portion 28 has a second groove 32, alongside the first groove 31.

The second groove 32 is adapted to receive at least partly a bracket element, preferably with an “L” profile. In this way, it is possible to attach the profiled element 24 to the bracket element by means of, e.g., a screw, thus preventing the head of the latter from protruding from the profiled element 24.

As anticipated above, the profiled element 24 comprises a main portion 26 opposite the retaining portion 28 and intended to be associated with one of the walls 3.

For this purpose, the profiled element 24 comprises at least one opening 33 made where the main portion 26 is located and configured to receive substantially the side of the wall 3 to size.

In particular, the opening 33 allows at least part of the side of the wall to be fitted within the main portion 26 in order to attach the profiled element to the wall 3. For this purpose, the opening 33 has a substantially complementary conformation to the side of the wall.

Conveniently, the joining means 23 comprise at least a second seal element 34 arranged in the opening 33 and, in use, intended to clamp the wall 3 in a sandwich-like manner.

Such a second seal element 34 also allows an airtight seal to be achieved at the main portion 26.

Specifically, the second seal element 34 comprises a first portion and a second portion 34a, 34b arranged on the two sides of the opening 33 so as to clamp the wall 3 in a sandwich-like manner. In detail, each of the two portions 34a, 34b has an abutment surface facing each other and intended, in use, to contact the wall received in the opening 33.

Preferably, at least one of the portions 34a, 34b has an abutment surface provided with a plurality of teeth 35.

Conveniently, the cabin 1 comprises a plurality of profiled elements 24 arranged to make a frame of at least one of the walls 3.

Preferably, the plurality of profiled elements 24 makes a frame of each of the walls 3.

According to one aspect of the present invention, advantageously, one of the side walls 3c, 3d is associated with the back wall 3b and with the access wall 3a in a removable manner.

This wall can thus be removed to expand the cabin and/or to join another cabin 1.

This arrangement is possible because the only wall required for the operation of the cabin 1 is the back wall 3b.

Appropriately, the cabin 1 comprises coupling means of the back wall 3b to at least one wall 3 of another cabin 1. It thus proves possible to join several cabins together by connecting their respective treatment spaces 4 to each other in order to make a larger cabin.

In particular, the coupling means are associated with the back wall 3b.

In fact, as anticipated above, the back wall 3b cannot be removed as it is critical to the operation of the cabin.

Thus, the present invention also covers a system for wellness treatments that comprises at least two cabins 1, according to the above, coupled together by interposition of the coupling means.

It has in practice been ascertained that the described invention achieves the intended objects, and in particular the fact is emphasized that the cabin according to the invention makes it possible to drastically reduce production time as well as cabin installation time.

In addition, such a cabin has a high degree of customization and flexibility, thus allowing the customer to make changes even while the work is in progress.

1. Cabin (1) for wellness treatments, particularly saunas, steam baths and the like comprising:
a containment structure (2) comprising a plurality of walls (3) coupled to each other and defining at least one treatment space (4) adapted to accommodate at least one user, said plurality of walls (3) comprising:
at least one access wall (3a) for the access to said treatment space (4),
at least one back wall (3b) opposite said access wall (3a), and
at least one pair of side walls (3c, 3d) opposite each other and located between said access wall (3a) and said back wall (3b); and
at least one air conditioning system (6) of said treatment space (4) comprising at least heating means (7) and at least one electronic management and control unit (U) of said heating means (7);
wherein said air conditioning system (6) is associated with said back wall (3b), each of said side walls (3c, 3d) being devoid of said heating means (7) and of said electronic management and control unit (U).

2. Cabin (1) according to claim 1, wherein said back wall (3b) comprises at least one housing seat (10) adapted to house at least part of said air conditioning system (6).

3. Cabin (1) according to claim 1, wherein said heating means (7) are uniquely and directly associated with said back wall (3b).

4. Cabin (1) according to claim 1, wherein said treatment space (4) comprises at least one shelf element (13) associated with said back wall (3b), said shelf element (13) comprising at least one cavity (14) in communication with said housing seat (10) and adapted to house at least part of said heating means (7) and/or of said electronic management and control unit (U).

5. Cabin (1) according to claim 1, wherein said heating means (7) comprise at least one steam production and dispensing unit (9).

6. Cabin (1) according to claim 1, wherein said shelf element (13) protrudes cantilevered from said back wall (3b) and extends transversely from the latter.

7. Cabin (1) according to claim 1, wherein said shelf element (13) comprises a supporting portion (15) of said user.

8. Cabin (1) according to claim 1, wherein said air conditioning system (6) comprises interception and regulation means for intercepting and regulating said steam which are associated with at least one of either said back wall (3b) or said shelf element (13).

9. Cabin (1) according to claim 1, wherein said containment structure (2) comprises an upper closing wall (3c) comprising at least one housing compartment (18) adapted to house said electronic management and control unit (U).

10. Cabin (1) according to claim 1, wherein said housing compartment (18) comprises an inlet port (19) and at least one leaf (20) associated with said inlet port (19) and movable between an opening position, wherein it is moved away from said inlet port (19) to allow access from the outside to said housing compartment (18) and to said electronic management and control unit (U), and a closure position, wherein it is arranged to cover said inlet port (19) to prevent access from the outside to said housing compartment (18) and to said electronic management and control unit (U).

11. Cabin (1) according to claim 1, wherein it comprises supporting means of at least one cover sheet of said user, said supporting means comprising at least one flexible element associated with said back wall and around which said cover sheet is at least partly rollable.

12. Cabin (1) according to claim 1, wherein at least one of said side walls (3c, 3d) is associated with said back wall (3b) and with said access wall (3a) in a removable manner.

13. Cabin (1) according to claim 1, wherein it comprises coupling means of said back wall (3b) to at least one wall (3) of another cabin (1).

14. System for wellness treatments, wherein it comprises at least two of said cabins (1) according to claim 1 coupled together by interposition of said coupling means.

15. System according to claim 14, wherein said coupling means are associated with said back wall (3b).
